(19) United States
(12) Patent Application Publication
(10) Pub. No.: US 2012/0219730 A1
(43) Pub. Date: Aug. 30, 2012

(54) PACKAGING MATERIAL HAVING A THREEDIMENSIONAL DECORATIVE PROPERTY

(76) Inventor: Dong Hwan Chung, Busan (KR)

(21) Appl. No.: 13/508,351

(22) PCT Filed: Nov. 3, 2010
(86) PCT No.: PCT/KR2010/007712

§ 371 Date: May 4, 2012

(30) Foreign Application Priority Data
Nov. 4, 2009 (KR) 10-2009-0106161

(51) Int. Cl. B65D 25/20; B44F 7/00

(52) U.S. Cl. 428/12

(57) ABSTRACT

The present invention relates to a packaging material having a three-dimensional decorative property, comprising a decorative collapsible plate which stands upright from the upper surface of the packaging material to provide a three-dimensional decorative property, and which can be utilized for various purposes after being used as a packaging material. A packaging material (1) having a three-dimensional decorative property according to the present invention is configured such that at least one decorative collapsible plate (3) is installed on the upper surface of either a packaging panel (2a) or packaging means (2b). The packaging panel (2a) is formed into two layers consisting of an upper packaging sheet (4a) and a lower packaging sheet (4b), and has a space (4c) therein. The upper packaging sheet (4a) has a cut-out portion (5). The packaging means (2b) has the cut-out portion (5) formed on the upper surface thereof, the lower packaging sheet (4b) installed in the upper inner portion thereof, and the space (4c) formed on the inside thereof. A lower support portion (3a) is placed beneath the cut-out portion (5) such that the decorative collapsible plate (3) stands upright when the packaging is laid down. In addition, a spacing piece (6) for adjusting the spacing (W) of the decorative collapsible plate (3) by means of sliding is installed, or a support arm (8) is integrally formed with the decorative collapsible plate (3) such that the support arm (8) is freely bendable in the forward and backward directions.

### TECHNICAL FIELD

The present invention relates to a packaging material having a three-dimensional decorative property, and more particularly, to a packaging material having a three-dimensional decorative property which adds a decorative property and an aesthetic value to the packaging panel such as packaging sheets, packaging panels and packaging boxes beyond its packaging function, upgrades a product by improving the value of the product by packaging it with the packaging material having a three-dimensional decorative property, and which can be utilized for various purposes after being used as a packaging material due to such a three-dimensional decorative property.

### BACKGROUND ART

In the case of the packaging material having a three-dimensional decorative property, in general, the function of a packaging material such as a packaging sheet and packaging box for packaging a product is limited to the packaging, and although in some cases the decorative property was increased by printing various designs or images on a surface of a packaging material, most of such packaging materials with an image printed on the surface thereof were used once and then discarded after being used as a packaging material, thereby resulting in massive waste of resources. Therefore, an image printed on the surface of the packaging material is not enough to provide a decorative property and upgrade the product.

### DETAILED DESCRIPTION OF THE INVENTION

### Technical Problem

The present invention has been made to solve the problems and it is an object of the present invention to provide a new concept of packaging material having a three-dimensional decorative property, comprising a decorative collapsible plate which has a three-dimensional decorative property and stands upright from an upper surface of an packaging material, rather than the traditional ways by which simply designs or images are printed thereon, and which can be utilized for various purposes including, without limitation, indoor interior decorations, pencil vase, memo holder, calendar, album, compartments and decorations directly decorating a product after being used as a packaging material.

### Technical Solution

In order to achieve an object of the present invention, a packaging material having a three-dimensional decorative property according to the present invention is configured such that at least one decorative collapsible plate is installed on the upper surface of either a packaging panel or packaging part. The packaging material is formed into two layers consisting of an upper packaging sheet and a lower packaging sheet and has a space therein. The upper packaging sheet has a cut-put portion. The packaging part has the cut-out portion formed on the upper surface thereof, the lower packaging sheet installed in the upper inner portion thereof, and the space formed on the inside thereof. A lower support portion is placed beneath the cut-out portion such that the decorative collapsible plate stands upright when the packaging is laid down. The decorative collapsible plate is integrally formed with the packaging panel or the packaging part so that it stands upright therefrom, as the case may be.

In addition, apart from the decorative collapsible plate installed on the upper surface of ether a packaging panel or packaging part, a spacing piece for adjusting the spacing of the decorative collapsible plate by means of sliding is installed, or a support arm is integrally formed with the decorative collapsible plate such that the support arm is freely bendable in the forward and backward directions as to have a space to store various stuffs by bending the support arm in either direction thereof after being used as a packaging material.

### Advantageous Effect

According to specific measures to solve the aforementioned problems, the present invention is a great invention having the effects that it increases a three dimensional decorative property by comprising a decorative collapsible plate which stands upright from the upper surface of a packaging panel or packaging part of the packaging material, upgrades the product packaged with the present invention, reduces massive waste of resources by utilizing the packaging material for various purposes including, without limitation, indoor interior decorations, memo holder, calendar, album, compartments and decorations directly decorating the product after being used as a packaging material, increases the value of the packaging material by applying various electronics, cosmetic or jewel box or miscellaneous goods thereto, and embodies a three-dimensional sculpture without any knife, scissors or glue.

### BRIEF DESCRIPTION OF DRAWINGS

FIGS. 1 through 2 are perspective and sectional views of a decorative collapsible plate installed on a packaging panel according to a preferred exemplary embodiment of the present invention.

FIG. 3 is a sectional view of a decorative collapsible plate installed on a packaging box according to a preferred exemplary embodiment of the present invention.

FIGS. 4 through 5 are perspective and sectional views of a spacing piece added according to the second exemplary embodiment of the present invention.

FIG. 6 is a sectional view of different configuration of a spacing piece according to the second exemplary embodiment of the present invention.

FIGS. 7 (A) through (D) are sectional views of various exemplary embodiments of a decorative collapsible plate in the present invention.

FIG. 8 is a perspective view of the third exemplary embodiment of the present invention.

FIGS. 9 through 10 are perspective views of various exemplary embodiments of the present invention.

FIG. 13 is a sectional view of another exemplary embodiment of a decorative collapsible plate in the present invention.

### BEST MODE

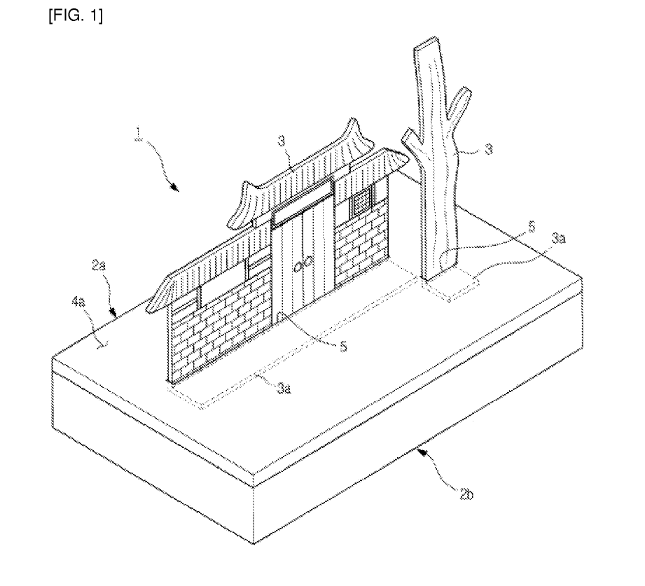

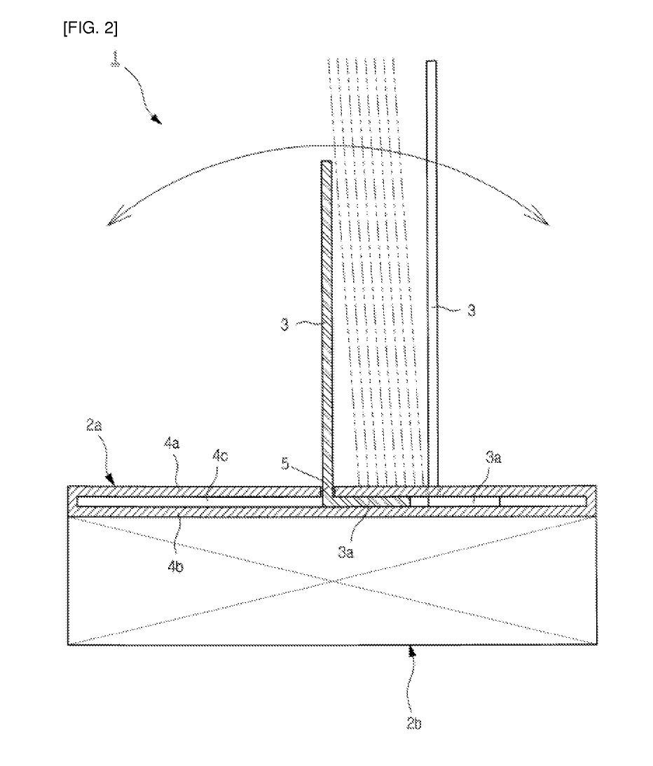

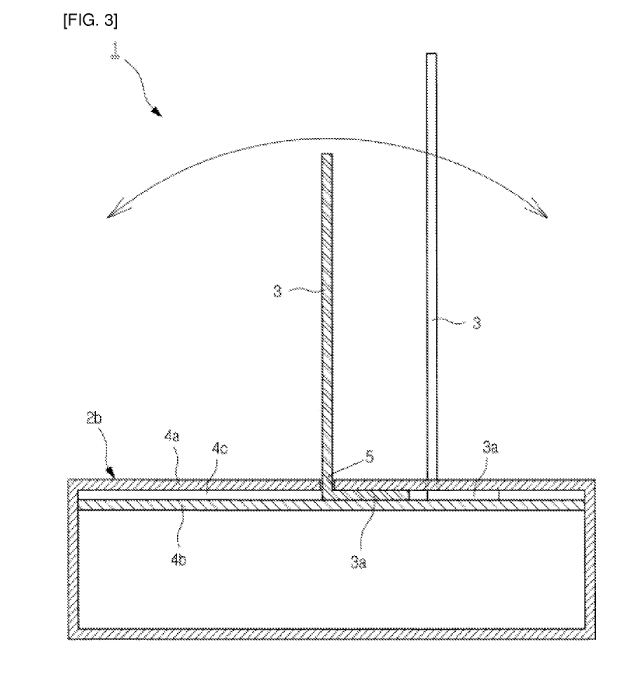

FIGS. 1 through 2 are perspective and sectional views of a decorative collapsible plate installed on a packaging panel according to a preferred exemplary embodiment of the present invention, and FIG. 3 is a sectional view of a decorative collapsible plate installed on a packaging box according to a preferred exemplary embodiment of the present invention, hereinafter, the present invention will be described in more detail with reference to accompany drawings.

The present invention relates to a packaging material (1). The packaging material (1) has at least one decorative collapsible plat installed on the upper surface of either a packaging panel (2a) attached to the surface of various packaging part (2b) (all sorts of product packaging boxes, cases and cards including, without limitation, greeting card and wedding invitation, pamphlet, book, fancy goods, etc; hereinafter referred to as ‘packaging part’)or packaging part (2b).

The decorative collapsible plate (3) which stands upright to provide a three-dimensional decorative property may further increase artistic value with artistic design by configuring a shape or pattern of the decorative collapsible plate with a painting or sculpture of domestic and foreign artists, a notable figure, various architectures and works of art or any kinds of animal and plant, or printing or attaching the image thereof. In addition, based on the target user, the application may vary, for children, a character of a fairy tale, cartoon or biography may be used. In order to upgrade the product packaged with the packaging material, the decorative collapsible plate (3) may be plated with gold or any others, have a texture like metal, glass, wood, stone, etc according to various techniques and have a texture and color as nature by utilizing a color of natural material such as insect, flower, grass, etc.

As shown in FIGS. 1 through 2, the packaging material (1) according to the present invention is configured such that a packaging panel (2a) on which two decorative collapsible plates (3) which stands upright from the upper surface thereof to provide a three-dimensional decorative property is installed on the upper surface of the packaging part (2b), therefore the present invention may put memos, business cards, calendars, photos, etc in the space between the decorative collapsible plates 3 by standing upright them after being used as a packaging material.

The packaging panel (2a) is formed into two layers consisting of an upper packaging sheet (4a) and a lower packaging sheet (4b) and has a space (4c) therein, and configured to have the cut-out portion (5) connecting to the space (4c) by cutting a part of the upper packaging sheet (4a) to place the lower surface of the decorative collapsible plate (3). A support portion (3a) which is integrally formed on the decorative collapsible plate 3 is installed on the inner portion of the space (4c) such that the support portion (3a) is bendable at the lower surface of the decorative collapsible plate (3). The decorative collapsible plate (3) stands upright from the upper surface of the cut-out portion (5) supported by the support portion (3a) placed in the space (4c). In addition, if necessary, a fixed or detachable lower support portion (3a) of the decorative collapsible plate (3) may be attached to a lower surface of an upper packaging sheet (4a) or an upper surface of a lower packaging sheet (4b) by using a glue, magnet, Velcro faster, double-sided tape, etc., and various means including, without limitation, a glue, magnet and Velcro faster may be used when a packaging panel (2a) is attached to a packaging part (2b).

The packaging panel (2a), if necessary, may be formed with an upper packaging sheet (4a) without a lower packaging sheet (4b), and have a cut-out portion (5) and insert a decorative collapsible pate (3) therein, in addition, the upper packaging sheet (4a) may be attached to the product or the packaging part (2b).

As shown in FIG. 3, the packaging material (1) may be formed to install a decorative collapsible plate having a three-dimensional decorative property, which stands upright from the packaging part (2b) including, without limitation, a packaging box instead of a packaging panel (2a), wherein a cut-out portion (5) is formed on an upper surface of the packaging part (2b). A support portion (3a) of the decorative collapsible plate (3) is placed therein. The lower packaging sheet (4b) is installed in the upper inner portion of thereof closely adhere to a lower support portion (3a) of the decorative collapsible plate (3), and have the space (4c) connecting with the cut-out portion (5) formed on the upper surface of the lower packaging sheet (4b).

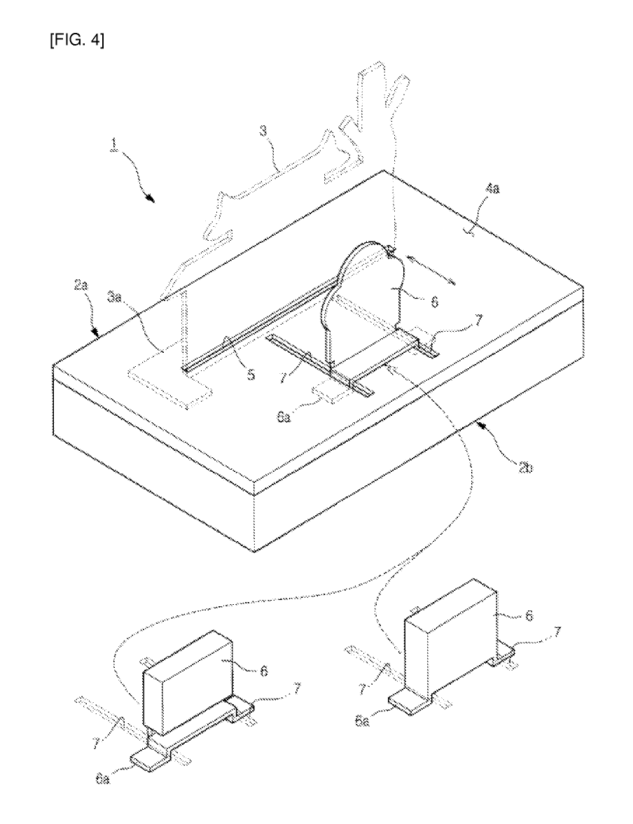

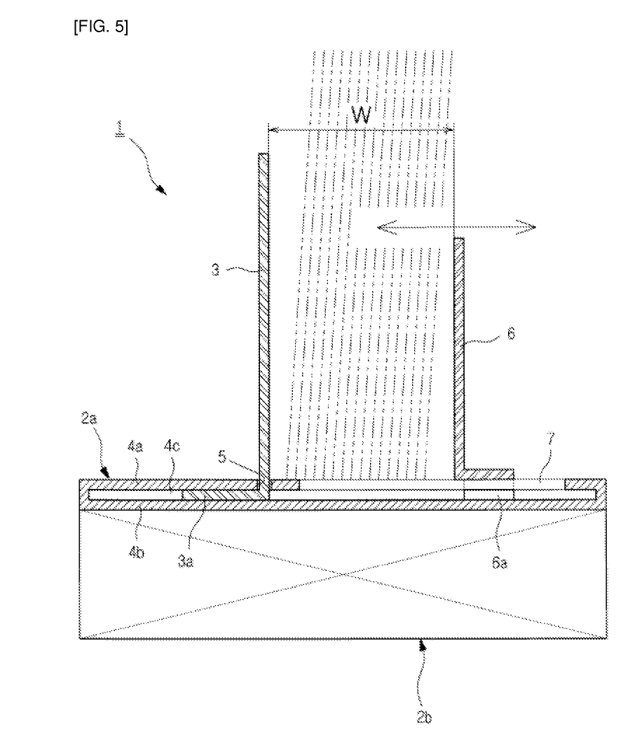

As the second exemplary embodiment of the present invention, in FIG. 4 through 5 and 6, a spacing piece (6) for adjusting the spacing (W) of the decorative collapsible plate (3) by means of sliding is installed apart from the decorative collapsible plate which is installed on the surface of either a packaging panel (2a) or packaging part (2b) and stands upright therefrom. A sliding cut-out portion (7) which penetrates space (4c) in the front or the rear sides at right angles to the decorative collapsible pate (3) is formed on an upper packaging sheet (4a) of the packaging panel (2a), and a slider support (6a) which supports the spacing piece (6) to stand upright and adjusts the spacing (W) of the decorative collapsible pate (3) in the sliding cut-out portion (7) is bended and formed on the lower surface of the spacing piece (6). The spacing piece (6) is applied in FIG. 3 in which a decorative collapsible pate (3) is installed on packaging part (2b) as well as a packaging panel (2a), a sliding cut-out portion (7) is formed on the upper surface of the packaging part (2b) at right angles to the decorative collapsible plate (3), thus the spacing (W) between the decorative collapsible plate (3) and the spacing piece (6) may be adjusted by means of sliding by installing a slider support (6a) of the spacing piece (6) on the sliding cut-out portion (7).

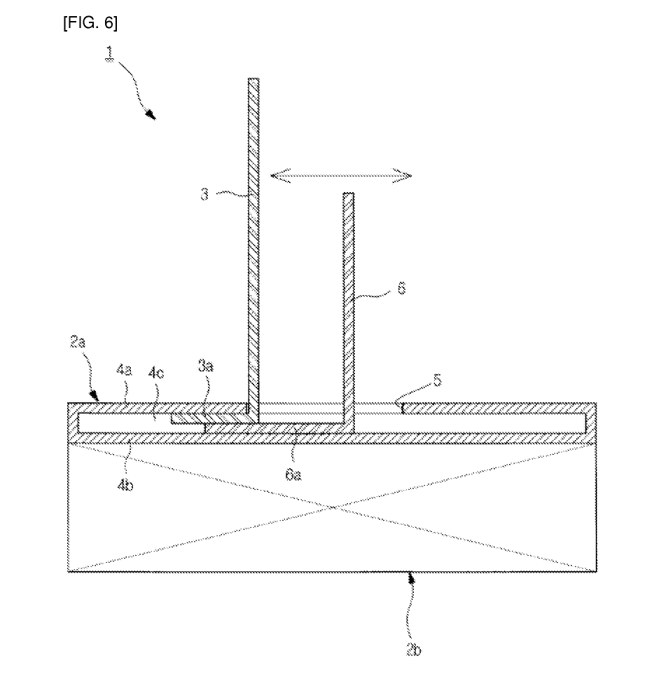

As shown in FIG. 6, the spacing piece (6) may be formed without any sliding cut-out portion (7) which lies at right angles to the decorative collapsible plate (3) installed on the upper packaging sheet (4a) of the packaging panel (2a) and install the lower slider support (6a) of the spacing piece (6) on the lower support portion (3a) of the decorative collapsible plate (3) by having a wide cut-out portion (5) in which the decorative collapsible plate (3) is installed so as to adjust the spacing (W) of the decorative collapsible plate (3) in the space (4c) of the packaging panel (2a) by means of sliding.

A decorative collapsible plate (3) and spacing piece (6) has a three-dimensional decorative property and may be differently formed in a box shape besides straight when looking at the side.

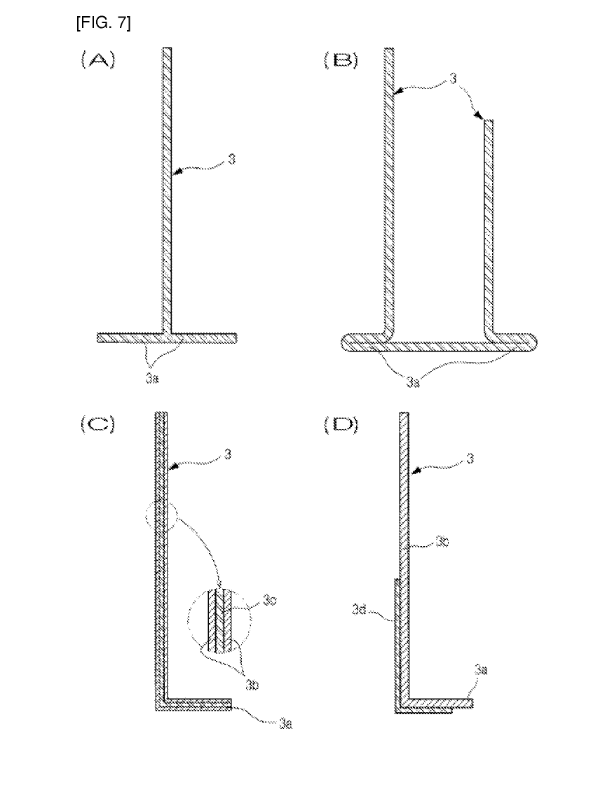

As FIG. 7 shows different forms of decorative collapsible plate (3) according the present invention. The decorative collapsible plate (3) may be covered with full iron as shown in FIG. 1 through 6. In one embodiment, the decorative collapsible plate (3) may be formed in the shape of L when looking at the side. Alternatively, the decorative collapsible plate (3) may be formed in a shape of ⊥ as shown in FIG. 7(A), and, thus, a support portion (3a) extends in forward and backward directions. In yet another embodiment, two decorative collapsible plates (3) standing upright may be formed by bending one iron plate as shown in 7(B), where a lower support portion (3a) extends in forward and backward directions. In yet another embodiment, a metal pin (3c) in the shape of a panel may be placed between paperboards installed in the back and forth sides as shown in 7(C). In yet another embodiment, the decorative collapsible plate (3) may be formed with a paperboard (3b) and an auxiliary metal plate (3d) may be attached to the decorative collapsible plate (3) and the lower support portion (3a) as shown in 7(D). Furthermore, the material of the decorative collapsible plate (3), the metal pin (3c) of the paperboard and the auxiliary metal pin (3d) may vary from an iron plate, other metals, PP film to a special paper which the configuration and material is differently variable, therefore, it includes the materials on the drawings, but not limited thereto.

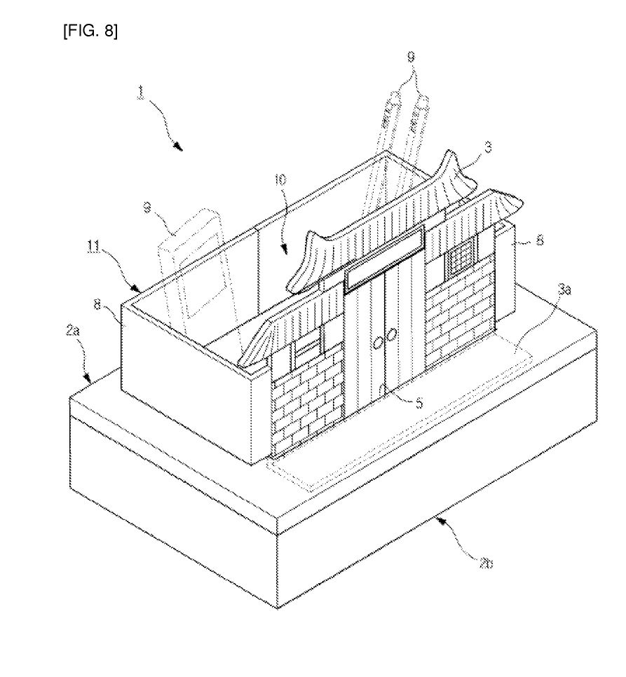

FIG. 8 is the third exemplary embodiment of the present invention. According to the third exemplary embodiment of the present invention, a support arm (8) is integrally formed with the decorative collapsible plate (3) in one side or both sides thereof which is installed on the surface of either a packaging panel (2a) or packaging part (2b) such that the support arm (8) is freely bendable in the forward and backward directions, and by standing the decorative collapsible plate (3) and bending the support arm (8) in the shape of square, circle, triangle, etc when seeing it on the flat in either direction of forward or backward as shown in FIG. 8, the packaging material may be formed as a compartment (11) having a space to store various items such as a cellular phone, remote control, frindle, personal articles, etc, and in order to easily hold and scarp, a anti-slip pad for items (9) such as a cellular phone, remote control, etc may be attached to the bottom surface or the inside of the support arm (8), as it may necessary, and the support arm (8) may play a role of a support preventing the decorative collapsible plate (3) from falling down in either direction of backward or forward.

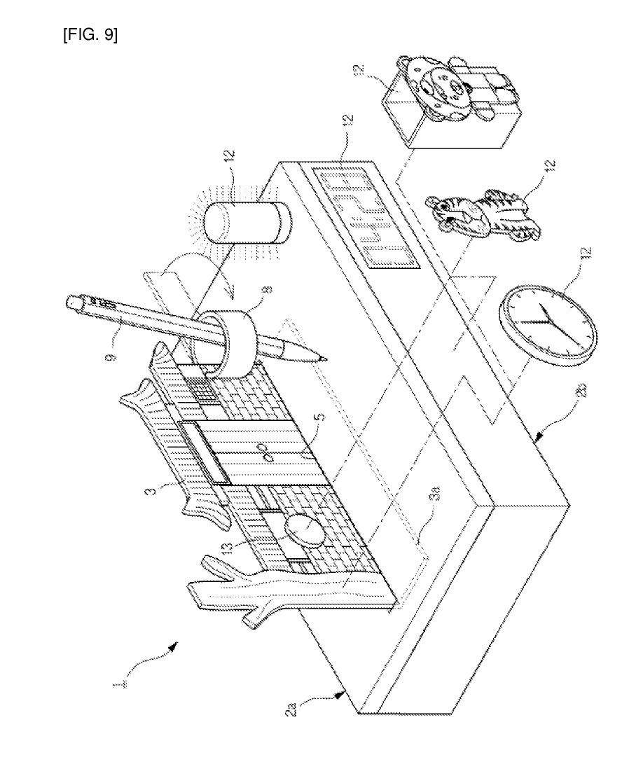

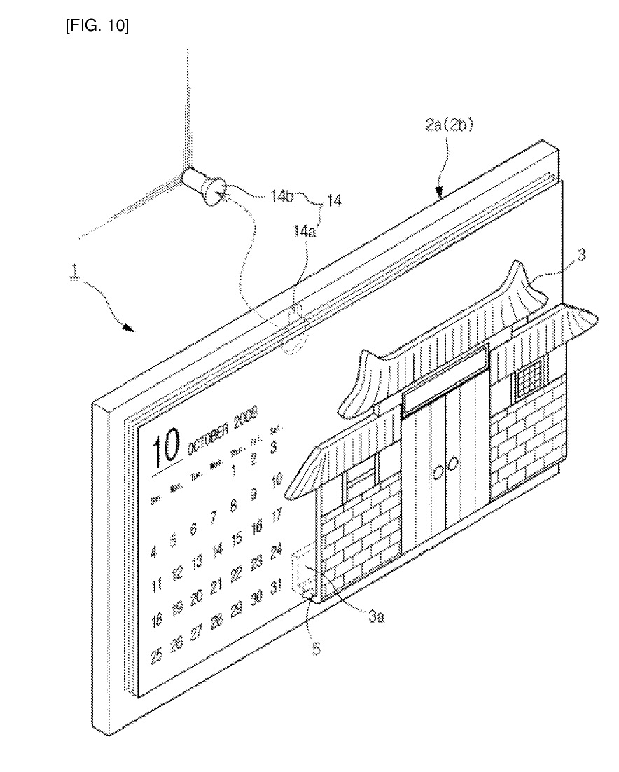

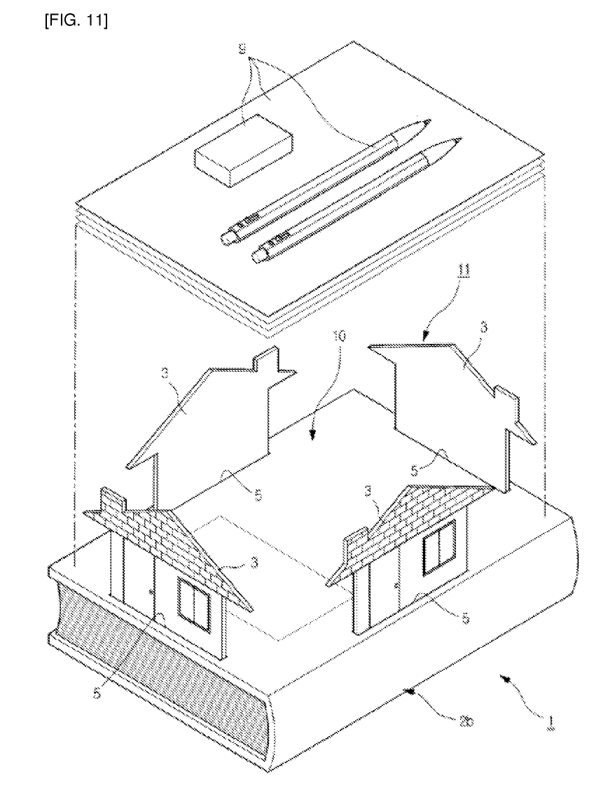

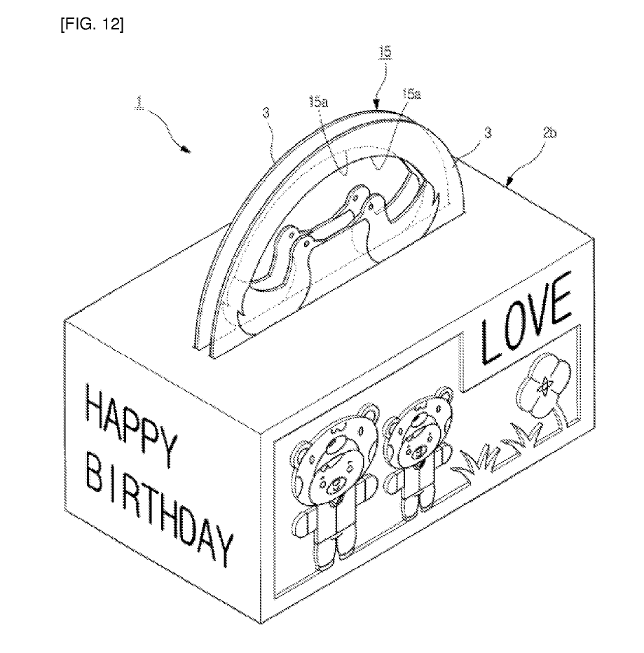

FIGS. 9 through 10 are an exemplary of embodiment of the present invention showing a variety of cases in which the packaging material (1) can be utilized for various purposes after being used as a packaging material, as shown in FIG. 9, the packaging material (1) having a decorative collapsible plate (3) installed on the upper surface of either a packaging panel (2a) or packaging part (2b) may install an extraneous matter (12) including, without limitation, a clock, decorative panel (a decorative collapsible plate (3) and any panel with various characters or special image used for decoration of the packaging material (1)), pencil vase and electronics (digital clock, radio, LED light, etc) on every surfaces thereof. Such extraneous matter may be installed on the surface of a packaging panel (2a), packaging part (2b), a decorative collapsible plate (3) or spacing piece (6) such that the extraneous is detachable by means of an attaching means (13) such as a permanent magnet or others. In addition, the detachable decorative panel in the diverse shapes and forms may be installed on the decorative collapsible plate (3) so as to change entire decorations and images of the decorative collapsible plate from time to time.

In FIG. 10, a rack (14a) formed on a packaging panel (2a) or packaging part (2b) which is installed on a decorative collapsible plate (3) and hanging means (14) consisted of a nail (14b) which is installed on an indoor wall or somewhere else are embodied. The rack (14a) hanged on the nail (14b) may be used as a wall decoration. As hanging means (14), a detachable magnet and Velcro faster may be installed on a wall and packaging material (1) instead of the nail (14b) and rack (14a). In this case, a decorative collapsible plate (3) is bended in parallel with the wall at an identical interval in the packaging panel (2a) or packaging part (2b) such that the decorative collapsible (3) is able to function as a calendar or album by placing a calendar insert or photo, etc in the inner portion thereof, and it may be used as a standing calendar, album or memo holder by standing it on a desk rather hanging it on the wall. Furthermore, it may be used as a memo holder by attaching a detachable magnet to every sides of the decorative collapsible plate (3).

Besides, if a book apples as a packaging part (2b) having the decorative collapsible plate (3) as shown in FIG. 11, the decorative collapsible pate (3) may be formed by imaging the content of the book, and if various cards such as a greeting card, wedding card, etc or an advertising campaign pamphlet as well as a book apply as a packaging part (2b), it can lead to the improvement of design of the card, and as shown in FIG.s, the decorative collapsible plate (3) has a storage space (10) therein by installing 2 through 4 decorative collapsible plates (3) which stand upright facing each other on the edge of the packaging panel (2a) or packaging part (2b), thus it may be used as a compartment and store various items (9) including paper, frindle, etc. Furthermore, as shown in FIG. 12, a wave penetration work (15a) which is penetrated from the front surface of the decorative collapsible plate (3) to the back surface thereof, and installed on the packaging panel (2a) or packaging part (2b) may be used as a strap (15) of the packaged product.

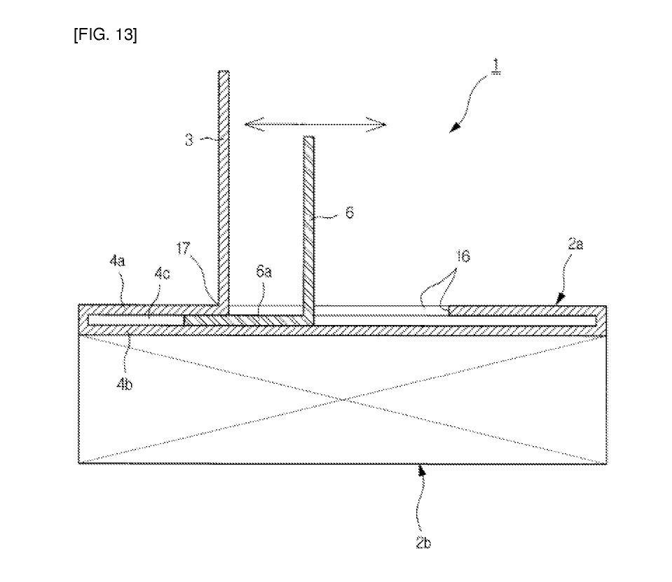

As shown in FIG. 13, if necessary, the packaging material (1) may install the decorative collapsible plate (3) which is integrally formed with the packaging panel (2a) or packaging part (2b). An outer cutting line (16) is formed by cutting an outline along the shape of the decorative collapsible plate (3), and the packaging material may install a hinged portion (17) to fold the decorative collapsible plate (3) without cutting any part of the lower side thereof. Besides, a lower slider support (6a) of a spacing piece (6) may be formed on the inner portion of the space (4c) as to adjust the spacing (W) of the decorative collapsible plate (3).

### Industrial Applicability

A packaging material according to the present invention has the effects of increasing a three-dimensional decorative property by comprising a decorative collapsible plate which stands upright from the upper surface of the packaging panel or packaging part of the packaging material; upgrading the product packaged with the present invention; reducing massive waste of resources by utilizing the packaging material for various purposes including, without limitation, indoor interior decorations, pencil vase, memo holder, calendar, album, compartments and decorations directly decorating the product after being used as a packaging material; increasing the value of the packaging material by applying various electronics, cosmetic or jewel box or miscellaneous goods to a packaging material according to the present invention; plus embodying a three-dimensional sculpture without any knife, scissors or glue.

1. A packaging material having a three-dimensional decorative property, comprising:
a packaging panel which is formed into two layers consisting of an upper packaging sheet and a lower packaging sheet, and has a space therein;
a cut-out portion which is cut out at the upper packaging sheet of the packaging panel and communicates with the space; and
a decorative collapsible plate at a lower part of which is integrally formed a support portion inwardly inserted into the cut-out portion and then into the space, said decorative collapsible plate being bent at the support portion and projecting upright in an upward direction.

2. A packaging material having a three-dimensional decorative property, comprising:
a packaging means having a space in an upper portion of a lower packaging sheet installed in an upper inner portion thereof;
a cut-out portion which is cut out at the upper portion of the packaging means and communicates with a space; and
a decorative collapsible plate at a lower part of which is integrally formed a support portion inwardly inserted into the cut-out portion and then into the space, said decorative collapsible plate being bent at the support portion and projecting upright in an upward direction.

3. A packaging material having a three-dimensional decorative property according to claim 1, further comprising a spacing piece which is installed on the upper surface of either a packaging panel or packaging means for the purpose of adjusting the spacing of the decorative collapsible plate by means of sliding is installed on the upper surface of either a packaging panel or packaging means.

4. A packaging material having a three-dimensional decorative property according to claim 3, wherein a sliding cut-out portion which lies at right angle to a decorative collapsible plate and penetrates a space is formed on the upper surface of either a packaging panel or packaging means and inserted into the lower inner portion of the spacing piece. A bendable slider support is integrally formed therewith such that the pacing piece stands upright.

5. A packaging material having a three-dimensional decorative property according to claim 3, wherein a lower slider support of the spacing piece is installed on the lower support portion of the decorative collapsible plate by having a wide cut-out portion in which the decorative collapsible plate is installed so as to adjust the spacing of the decorative collapsible plate in the space by means of sliding.

6. A packaging material having a three-dimensional decorative property according to claim 1, wherein two decorative collapsible plates stand upright by means of bending one iron plate.

7. A packaging material having a three-dimensional decorative property according to claim 1, wherein a metal pin in the shape of a panel might be placed between paperboards installed in the back and forth sides

8. A packaging material having a three-dimensional decorative property according to claim 1, wherein said decorative collapsible plate is made of paperboards, plus an auxiliary metal pin is attached to the decorative collapsible plate and the support portion.

9. A packaging material having a three-dimensional decorative property according to claim 1, wherein a support arm is integrally formed with the decorative collapsible plate such that the support arm is freely bendable in forward and backward direction as to store items.

10. A packaging material having a three-dimensional decorative property according to claim 1, wherein an extraneous matter selected from among a clock, decorative panel, pencil vase and electronics is installed on the surface of either a packaging panel, packaging means, a decorative collapsible plate or spacing piece.

11. A packaging material having a three-dimensional decorative property according to claim 10, wherein a detachable extraneous matter by using an attaching means such as a magnet is installed on the surface of either a packaging panel packaging means, a decorative collapsible plate or spacing piece.

12. A packaging material having a three-dimensional decorative property according to claim 1, wherein a rack formed on a packaging panel or packaging means which is installed on a decorative collapsible plate and hanging means consisted of a nail which is installed on an indoor wall or somewhere else can be used as a wall decoration after being used as a packaging material is embodies.

13. A packaging material having a three-dimensional decorative property according to claim 1, wherein a number of decorative collapsible plates which stand upright facing each other are installed on the edge of the packaging panel or packaging means so as to use as a compartment and store various items in the inner portion of the decorative collapsible plate.

14. A packaging material having a three-dimensional decorative property according to claim 1, wherein a wave penetration work penetrated from the front surface of the decorative collapsible plate to the back surface thereof is installed, thus it may be used as a strap of the packaged product.

15. A packaging material having a three-dimensional decorative property, comprising:
a packaging panel which is formed into two layers consisting of an upper packaging sheet and a lower packaging sheet, and has a space therein;
a decorative collapsible plate which projects upright in an upward direction in such a way that an outer cutting line is cut out along an outline at an upper portion of a packaging panel, and a hinged portion for the purpose of folding without cutting out part of the lower side thereof; and
a spacing piece which serves to slide adjust a spacing from the decorative collapsible plate in such a way to insert a lower slider support into a space of a lower side of the decorative collapsible plate.

16. A packaging material having a three-dimensional decorative property, comprising:
a packaging means which has a space at an upper side of a lower packaging sheet disposed at an inner, upper side;
a decorative collapsible plate which projects upright in an upward direction in such a way that an outer cutting line is cut out along an outline at an upper portion of a packaging means, and a hinged portion for the purpose of folding without cutting out part of the lower side thereof; and
a spacing piece which serves to slide adjust a spacing from the decorative collapsible plate in such a way to insert a lower slider support into a space of a lower side of the decorative collapsible plate.
